(19) United States
(12) Patent Application Publication
(10) Pub. No.: US 2004/0060459 A1
(43) Pub. Date: Apr. 1, 2004

(54) Draining unit and press including such units

(75) Inventors: Alain Baranger, La Chapelle Rousselin (FR); Noel Brachet, La Possonniere (FR); Luc Godart, Toutlemonde (FR)

Correspondence Address: YOUNG & THOMPSON, 745 SOUTH 23RD STREET 2ND FLOOR, ARLINGTON, VA, 22202

(73) Assignee: VASLIN BUCHER, CHALONNES SUR LOIRE (FR)

(21) Appl. No.: 10/670,227

(22) Filed: Sep. 26, 2003

(30) Foreign Application Priority Data
Sep. 27, 2002 (FR) 02 12033

(51) Int. Cl. B30B 9/02

(52) U.S. Cl. 100/104

(57) ABSTRACT

The invention concerns a draining unit for a press or maceration vat and a press including such units.

A draining unit particularly for a pneumatic press, comprising at least one elongated, profiled element (1) containing a plurality of spread-out holes (2), said element (1) extending along the internal wall (3) of the vat of the press and forming a drainage channel (4) together with the wall through contact at two longitudinal side edges, characterised in that the profiled element (1) is interlocked with said wall (3) at one (5) of its side edges (5,5′) by means of a connection (6) with an ability to pivot and to hold in the pivoted position, and is provided with at least one latching means (7,7′) adapted to lock said profiled element (1) movably in a position with its two side edges (5,5′) resting against said internal wall (3) so as to form the drainage channel (4).

### DESCRIPTION

The invention concerns the field of presses, in particular means for collecting and discharging juices located in the vat of such a press. Its subject is a draining unit for a press or maceration vat, in particular for a pneumatic press, and a press equipped with at least one such unit.

Apparatus for separating liquids and solids, commonly described as presses, wherein longitudinal drainage channels are formed by means of profiled elements containing holes, on the internal surface of the wall of the vat, extending along the generating lines of the corresponding vats of generally cylindrical shape, are already known from document FR-A-2 336 241.

These profiled elements, which also form a filtering screen, are clearly subject to wear of the orifices (generally oblong holes or slots) provided in their wall by parts of the pressed materials coming to bear on said elements or by solid pieces present in the juices. They therefore have to be cleaned regularly to avoid loss of effectiveness of the press in question or even total blockage of the juice outlet.

Now it has been found in practice that external cleaning with a jet of water and/or by brushing said elements, which remain in position in the vat, did not result in any substantial elimination of the pieces blocking said orifices for the passage and filtering of juices. These pieces remain fixed on the internal surfaces of said elements or accumulate in the drainage channels.

It has therefore been proposed to install said profiled elements detachably in said vat and to take them out at each cleaning operation, so that access can be obtained, on the one hand, to both surfaces of said elements and, on the other hand, to the parts of the wall of the vat normally covered by said elements.

These detaching and re-mounting operations are nevertheless tedious, laborious and time-consuming. Moreover owing to the wear and deformation which occur during use of the press it may be difficult to re-position the elements, even if an effort is made to mark and index them.

The particular aim of the invention is to overcome these limitations and disadvantages.

To this end its subject is a draining unit especially for a maceration vat or press (in particular a pneumatic press), comprising at least one elongated, profiled element which may possibly contain a plurality of spread-out holes, said element extending along the internal wall of the vat of the press and forming a drainage channel together with the wall through contact at two longitudinal side edges, characterised in that the profiled element is interlocked with said wall at one of its side edges by means of a connection with an ability to pivot, and is provided with at least one latching and/or retaining means adapted to lock said profiled element in a position with its two side edges resting against said internal wall so as to form the drainage channel.

The invention will be understood better from the following description which relates to a preferred embodiment. This is given as a non-restrictive example and will be explained with reference to the accompanying diagrammatic drawings. In the drawings:

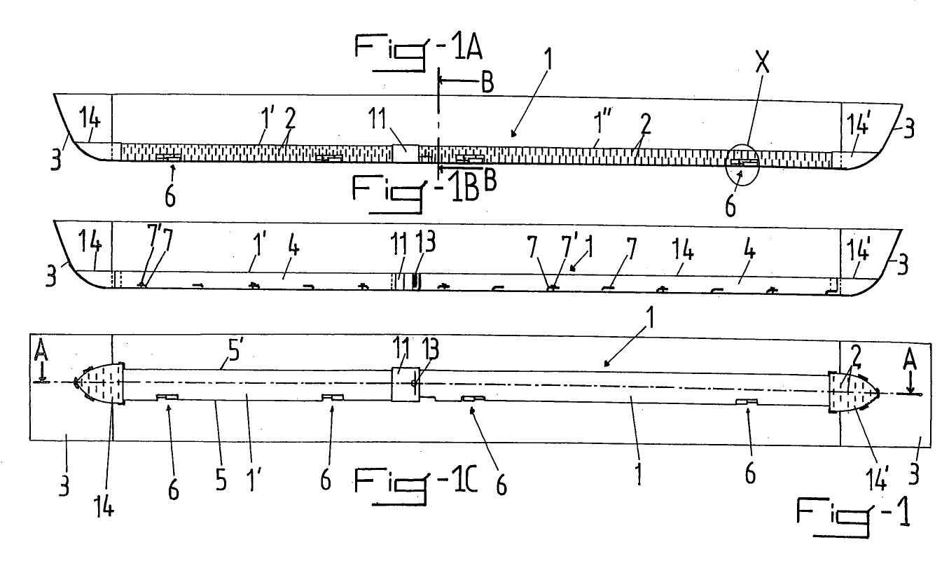

FIGS. 1A, 1B and 1C are views respectively in side elevation, in longitudinal section along the line A-A and from above, of a draining unit according to the invention with a profiled element in two parts;

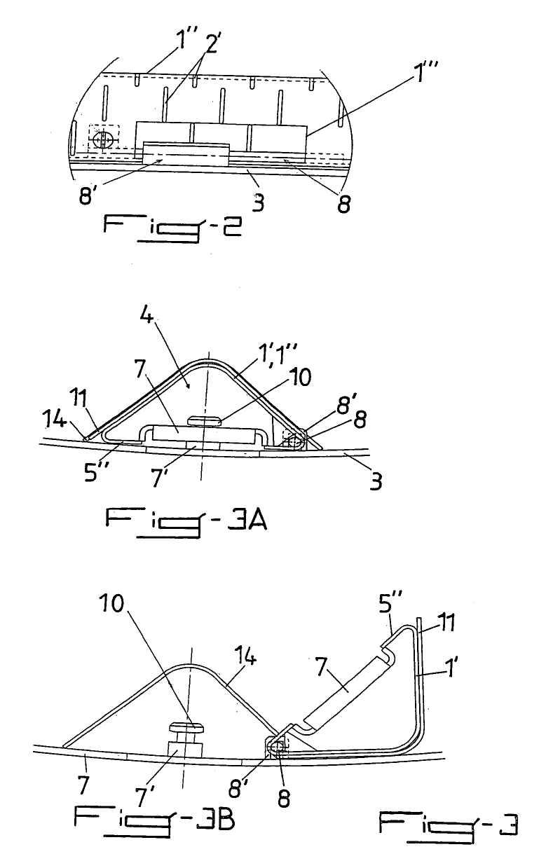

FIG. 2 is a view on a different scale of the detail X in FIG. 1A;

FIGS. 3A and 3B are views in section along the line B-B in FIG. 1A, with the profiled element respectively in a position turned down to form a drainage channel and in an open, folded-back position (for cleaning);

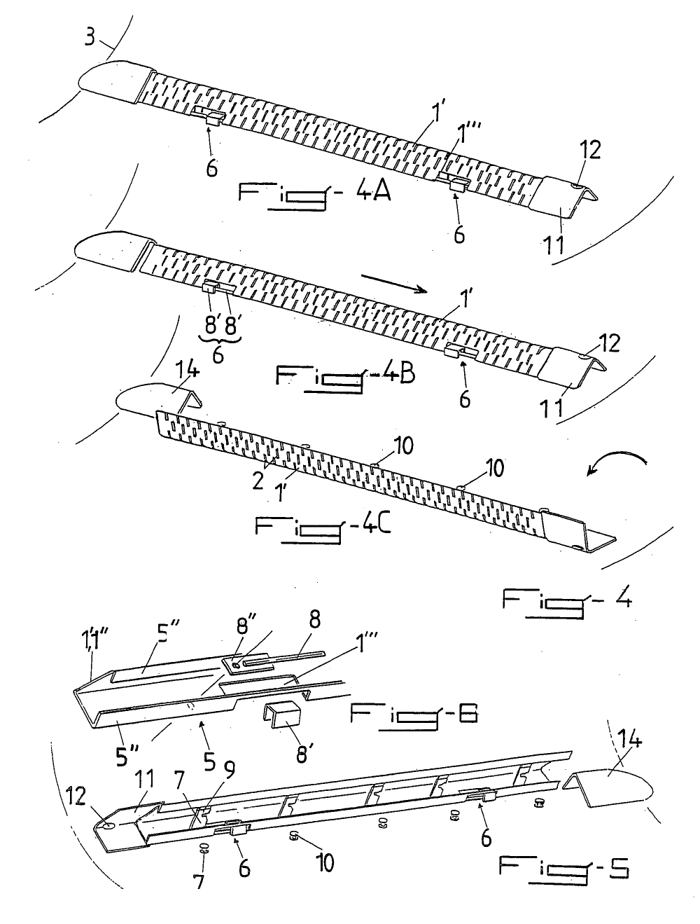

FIGS. 4A, 4B and 4C are perspective views showing the first part of the profiled element of the draining unit, respectively in a turned-down, latched position (FIG. 4A), in a turned-down, unlatched position (FIG. 4B) and in a folded-back, open position;

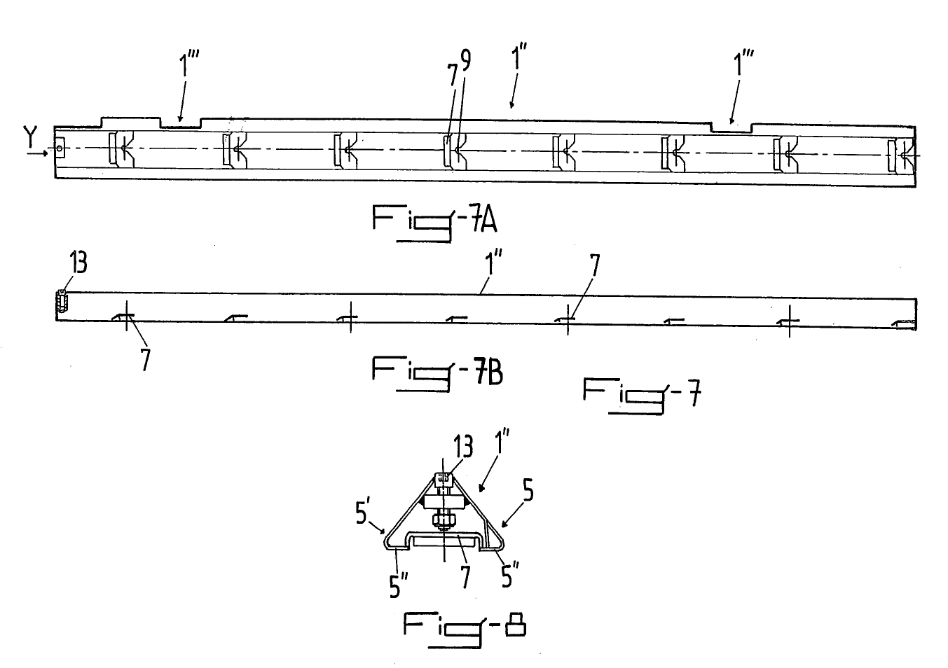

FIG. 5 is a perspective view of the object shown in FIG. 4C, from a different angle;

FIG. 6 is a partial, exploded view of a device forming part of the pivot connection;

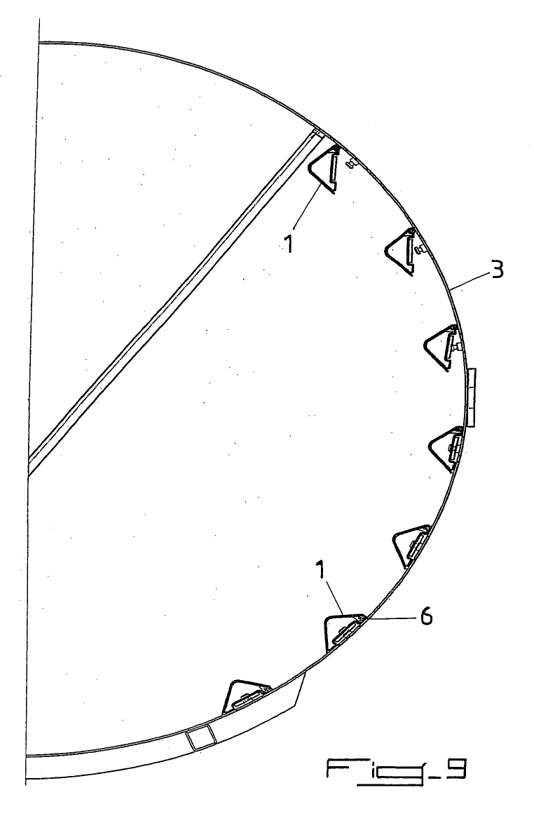

FIGS. 7A and 7B are views of the second part of the profiled element, respectively from below and in side elevation with transparency;

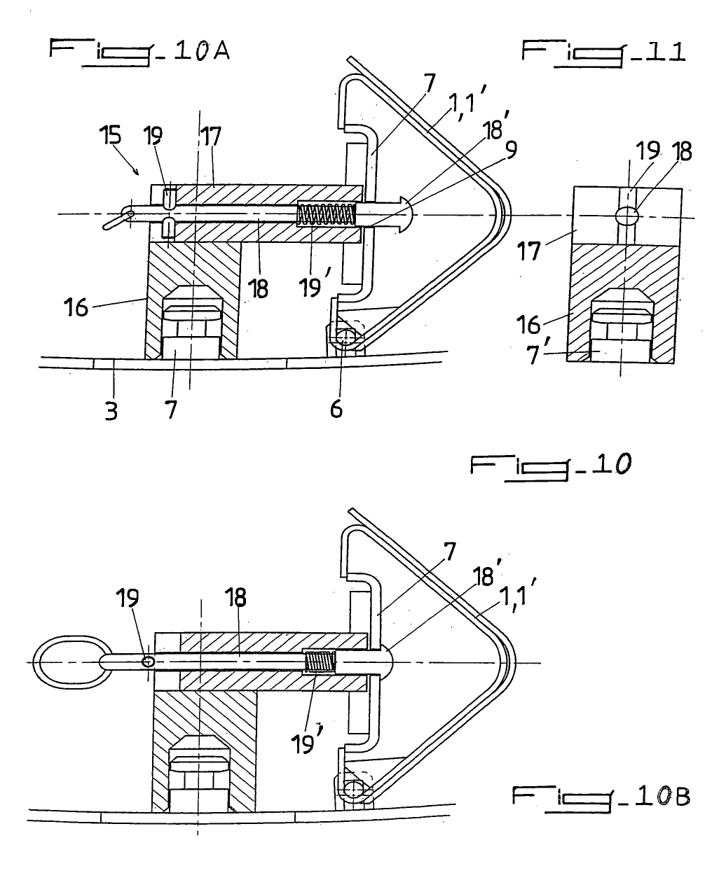

FIG. 8 is a view of the object shown in FIG. 7A, in the direction Y;

FIG. 9 is a partial, cross-sectional view of a vat of a press comprising draining units according to the invention;

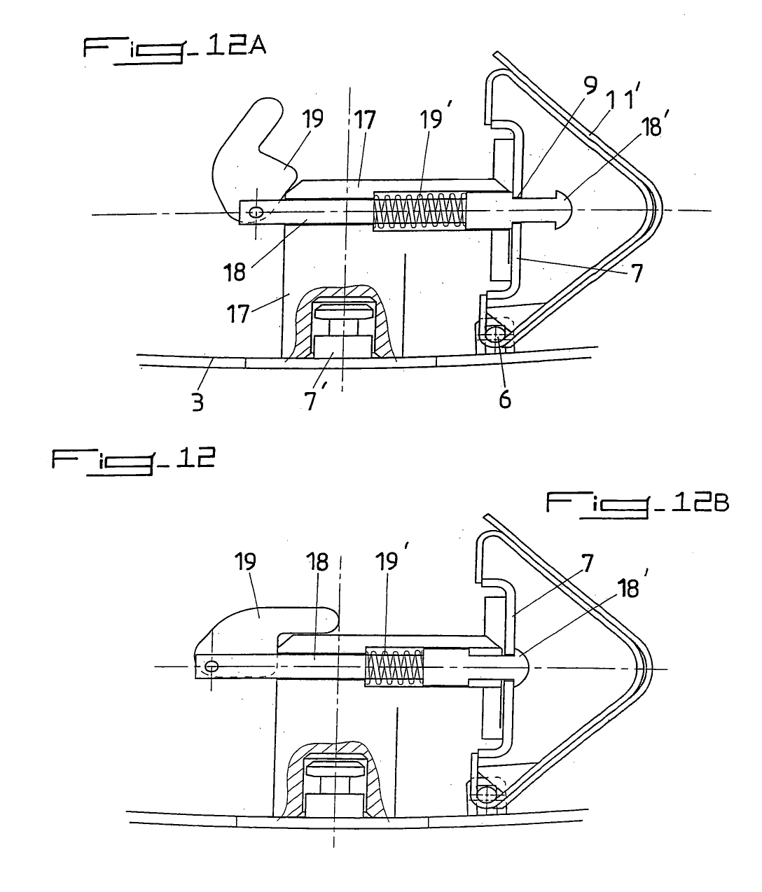

FIGS. 10A and 10B are views partly in section and in side elevation of a holding device in a first version of a first embodiment of the invention, respectively in the unlatched and latched condition;

FIG. 11 is a view of part of the holding device shown in FIG. 10A, from the left;

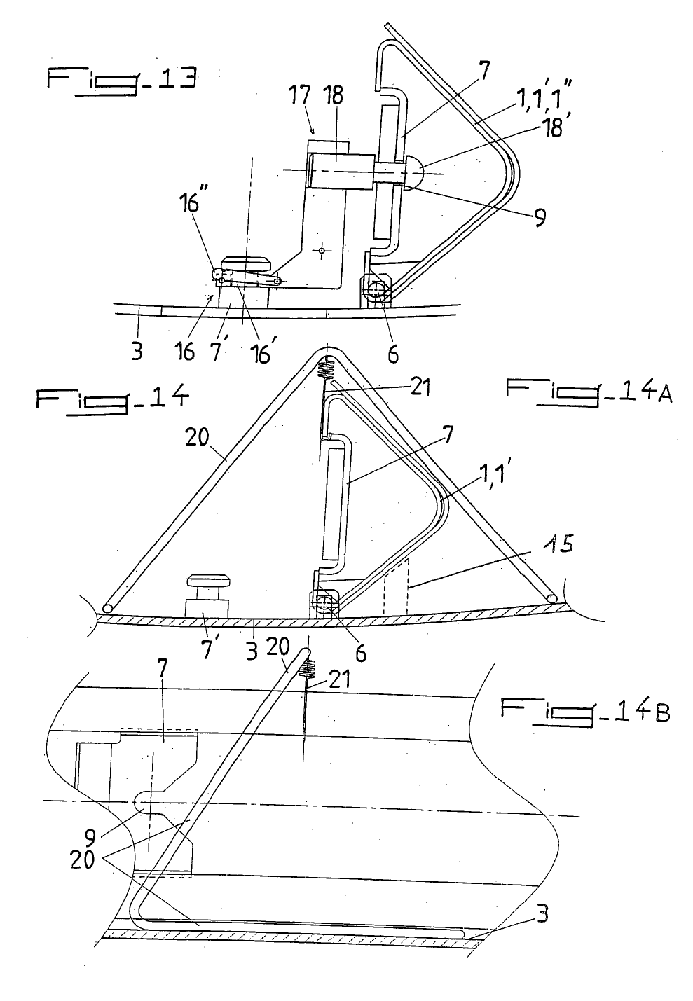

FIGS. 12A and 12B are views partly in section and in side elevation of a holding device in a second version of a first embodiment of the invention, respectively in the unlatched and latched condition;

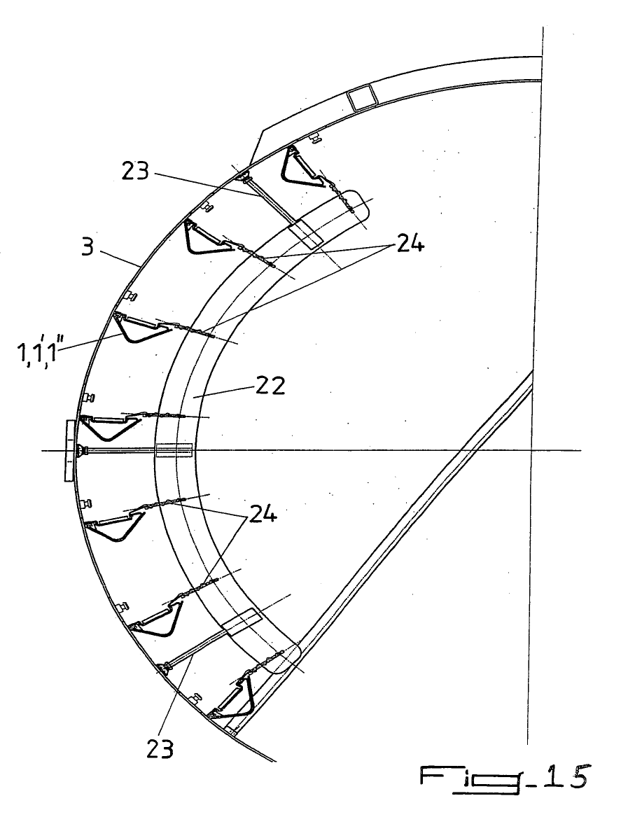

FIG. 13 is a view in side elevation of a holding device in a third version of a first embodiment of the invention, in the latched condition;

FIG. 14A is a view in side elevation of a holding device in a second embodiment of the invention;

FIG. 14B is a view of part of the device shown in FIG. 14A, from the left;

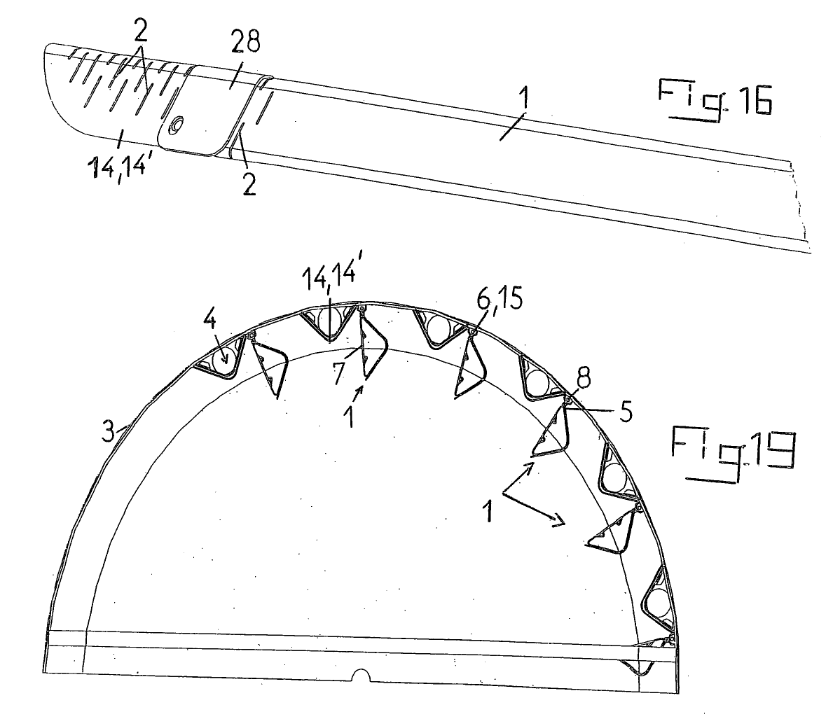

FIG. 15 is a view in cross-section of part of a vat of a press fitted with a holding device according to a third embodiment of the invention;

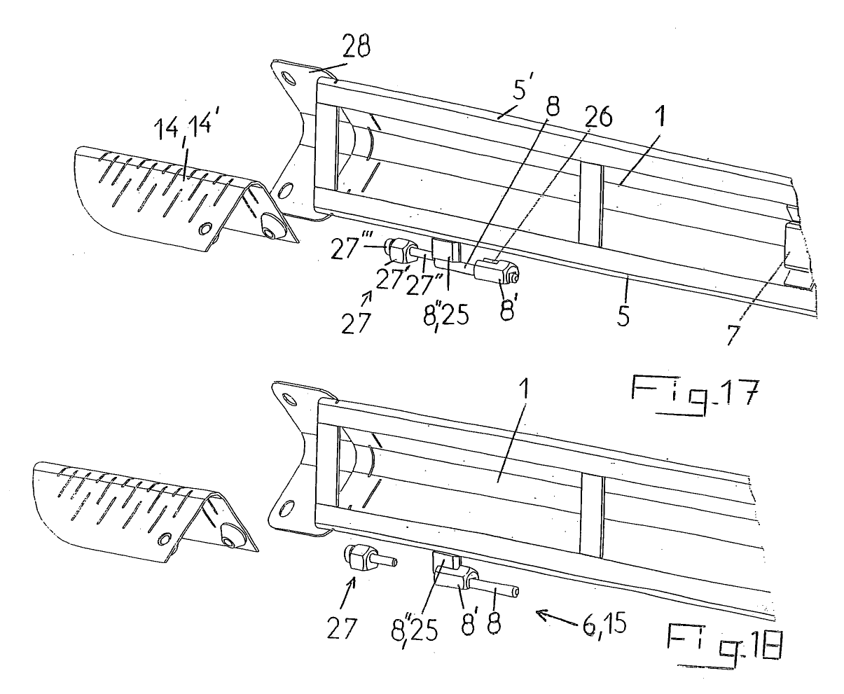

FIGS. 16, 17 and 18 are perspective views of part of a draining unit according to a fifth embodiment of the invention, with the profiled element successively in the turned-down position, in the raised, non-locked position and in the raised position with locking (after translational displacement);

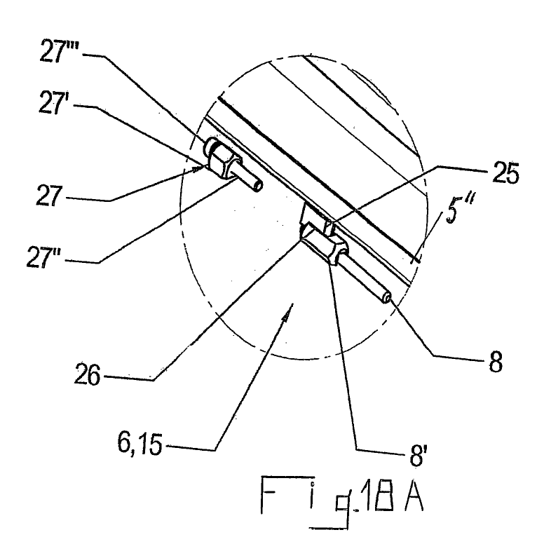

FIG. 18A is a drawing on a different scale of a detail from FIG. 18, and

FIG. 19 is a view in side elevation showing a group of draining units according to the fifth embodiment, mounted on the wall of a press vat respectively in the raised position with locking and in the turned-down position.

As shown particularly in FIG. 1 of the accompanying drawings, the draining unit is made up of at least one profiled element 1 which is elongated and generally contains a plurality of holes 2 (for example in the form of slots) spread out (substantially uniformly over its surface). The element (1; 1′; 1″) extends along the internal wall of the vat of the press or the internal surface of the wall and forms a drainage channel 4 together with it, through contact with the wall at its two longitudinal side edges.

In accordance with the invention the profiled element 1 is interlocked with the wall 3 at one 5 of its side edges 5, 5′, by means of a connection 6 with an ability to pivot, and is provided with at least one latching and/or retaining means 7,7′; 14,14′ adapted to effect detachable locking of the profiled element 1 in a turned-down position, with its two side edges 5,5′ (preferably folded-back portions thereof) resting against the internal wall 3 so as to form the drainage channel 4.

The invention thus makes it possible to clean both surfaces or sides (external and internal) of the profiled element 1 simply by pivoting about the pivot connection 6 (see FIGS. 3A and 3B), and also to clean—by direct access—the part of the wall 3 of the vat which forms the bottom of the drainage channel 4 and which is covered by the profiled element 1 in the turned-down position or use position of the latter (FIG. 3A).

In a preferred embodiment of the invention the pivot connection is made by at least two aligned hinge plate devices or hinge devices 6 which allow, in addition to the pivoting movement, limited relative displacement by translation between the profiled element 1 and the wall 3 of the vat in a longitudinal direction parallel with the axis of pivoting.

In an advantageous version each hinge plate device or hinge device 6 is made up of a spindle 8 interlocked with one 5 of the side edges 5,5′ of the profiled element 1 and at least one eyelet or hinge 8′, preferably of tubular structure, which is fixed rigidly on the wall 3 of the vat. The spindle 8 and the at least one eyelet or hinge 8′ are mounted and extend in such a way that they can slide over a predetermined distance.

To permit the desired limited sliding the spindle may be mounted at an indentation 1″′ in the wall of the profiled element 1 and will have an exposed part of a length greater than that of the hinge 8′. The spindle 8 may for example be integral with a member in the form of a plate 8″ or 25 which will be interlocked with the profiled element 1 (see FIGS. 2, 6, 17 and 18), for example by welding or screwing (enabling complete dismantling).

Each latching means is generally formed advantageously by two parts 7 and 7′, of which 7 is interlocked with the profiled element 1 and the other 7′ with the wall 3 of the vat. The two parts 7,7′ may be put into mutual engagement to lock the profiled element 1 in position, and may be disengaged by translation of the profiled element 1 in opposite directions (FIGS. 1 and 3).

In a possible form of the invention and as shown in FIGS. 1B, 1C, 3, 5, 7 and 8, each latching means, on the one hand, comprises a plate 7 fixed on the profiled element 1 in a trough shape, so that it is located in the drainage channel 4 when the element 1 is turned down against the wall 3 of the vat, and having an indentation defining an eyelet 9. Each latching means, on the other hand, comprises an anchoring stud or pin 7′ with a head 10 of radial dimensions greater than those of the eyelet 9 (in particular larger than the width of the indentation at its bottom). The profiled element 1 is advantageously fitted with a plurality of regularly spaced plates 7 designed to cooperate with a plurality of corresponding studs or pins 7′.

Each eyelet 9 is advantageously preceded by a guiding and centring indentation (for example of substantially triangular or frustoconical shape). Each head 10 is mounted on a recessed part of the shank of the corresponding stud 7′ and each plate 7 is in intimate contact (possibly being subjected to slight deformation) with the lower surface of a head 10, in the latched position of the corresponding part 1′,1″ (with the pins 7′ located in the eyelets 9).

Alternatively the plates 7 might equally have no indentations 9 and the studs 7′ might be replaced by tongues (for example Z-shaped ones), with a portion fixed to the wall of the vat and the other end adapted to come into engagement on a plate 7 during the latching movement of 1 or of 1′,1″.

The latching means 7,7′ might equally be made up of indentations formed at an external shoulder of the side edge 5′ opposite the edge 5 with the pivot connection 6, in which anchoring pins are slid into engagement.

To enable the draining unit to resist the pressures exerted during the pressing phases and to ensure that the pressures are spread over the wall 3 of the vat, the longitudinal side edges 5,5′ of the trough-shaped profiled element 1 may be extended by shoulders 5″ folded inwards, forming two parallel bearing strips for the profiled element 1 in the position where it is turned down to form the drainage channel 4.

As already disclosed in above-mentioned document FR-A-2 336 241, the profiled element 1 may be shaped so that, in its turned-down position, it cooperates with the wall 3 of the vat to define a drainage channel 4 of triangular section (with element 1 in the form of angle) or in semi-circular, semi-elliptical or rectangular section.

To facilitate its production, mounting and handling, provision may advantageously be made for the profiled element 1 to be formed by two separate, aligned and adjoining component parts 1′,1″, with their respective latching means 7,7′ engaging and disengaging in opposite directions. The first 1′ of the parts 1′,1″ has a profiled covering member 11, possibly containing holes, at its end facing the other part 1″. The covering member bears on and partially extends over the second part 1″ when both parts 1′ and 1″ are turned down against the wall 3 of the vat, and defines the portion of drainage channel 4 in the space which separates the two parts 1′ and 1″ in their respective latched positions.

The covering member 11 preferably has a cross-sectional shape similar to that of the two parts 1′ and 1″ and is provided with a catch hole or unlocking hole 12, and the second part 1″ is provided with a retractable locking pin or finger 13 at its end facing towards the first part 1′. The hole 12 and the finger or pin 13 are located in a mutually coincident configuration, allowing the finger or pin 13 to extend into or through the hole 12, substantially with corresponding shaping, when the first and second parts 1′ and 1″ are in their respective latching positions.

The space between the parts 1′ and 1″ in the latched position will be sufficient to allow the parts to slide in order to unlatch.

Insertion of the finger or pin 13 in the hole 12 may either take place automatically (with the finger pre-tensioned for example by a compression spring) or result from the action of a tool (for example screw/nut).

To assist the holding of the profiled element 1 in the latched position and to provide protected clearance of the drainage channel 4 into the juice-outlet orifices, each of the two components parts 1′ and 1″, when in its respective latched position, has its end opposite the end near the other part 1″ and 1′ engaged below or in a retaining clip 14, 14′ fixed on the wall 3 of the vat. Each of the clips 14′,14″ is preferably in the form of a portion of profiled element, either perforated or not (solid), having a sectional shape substantially similar to that of the component parts 1′,1″ and defining one end of the corresponding drainage channel 4 together with the wall 3 of the vat.

The retaining clips 14, 14′ also provide protection for the orifices through which the juices flow out of the vat of the press.

In an additional improvement of the invention, shown in the accompanying drawings, the profiled element 1 or each component part 1′,1″ thereof may be associated with a holding device 15 capable of holding the element 1 or part 1′,1″ in a specific rotary position about the axis of its pivot connection 6, described as the open position, in which the side edge 5′ of the element 1 or part 1′,1″ which is not joined to the wall 3 by the connection 6, is located at a spacing from the wall.

The aim of the additional improvement is to facilitate washing of the drains and to limit handling during the washing process. Now since the drain elements are arranged on a hoop portion, leaving the drains in the unlatched position, freely rotating about their hinges, would not allow the set of drains to be kept in the same position: open, partly open or closed (see FIG. 9). This random arrangement makes the washing operation difficult, especially as it is desirable to wash each of the elements 1 inside and out.

The above-mentioned improvement thus makes it possible to propose a system for keeping or indexing the drains in a specific open position and to put all the drains in the same position.

As shown in FIGS. 10 to 19 of the accompanying drawings each holding device 15 preferably locks the element 1 or part 1′,1″ concerned movably, in an intermediate position between the two possible rotary end positions (turned down/right open).

The position of the element 1 or part 1′,1″ about the axis of its pivot connection 6 advantageously corresponds substantially to rotation through between 45° and 135°, preferably about 90°, relative to its respective turned-down position in which the element or part forms a corresponding drainage channel 4 or portion of drainage channel.

In a first embodiment of the invention shown in FIGS. 10 to 13 of the accompanying drawings the element 1 or each part 1′,1″ is associated with at least one holding device 15 with a view to locking it in an open position. The device 15, on the one hand, comprises a lower portion 16 which forms a base and comes into engagement with or is anchored on the part 7′ of the latching means 7,7′ interlocked with the wall 3 of the vat and possibly bearing on that wall and, on the other hand, comprises an upper portion 17 carrying a means 18 for engaging the part 7 of the latching means 7,7′ interlocked with the element 1 or part 1′,1″ in question, preferably a retaining pin 18 with an enlarged head 18′ which comes into engagement at the indentation or an indentation 9 in the part 7.

When the lower portion 16 does not rest on the wall 3 it may advantageously have a part 16′ positively engaging the part 7′ of the latching means 7,7′ which is interlocked with the wall 3′ of the vat and equipped with a movable latching means 16″ in the engaged position (FIG. 13).

In addition the engagement means 18 may advantageously comprise a retaining pin which is mounted movably in the upper portion 17 of the holding device 15 in question and equipped with a means 19 for latching the pin in a retracted position for retaining the element 1 or part 1′,1″ in question and with a resilient means 19′ which urges the pin 18 into a stretched, releasing position (FIGS. 10, 11 and 12).

The latching means 19 may comprise a bayonet-type latching/unlatching mechanism (FIGS. 10 and 11) associated with a handling member (for example a ring for gripping). Alternatively it may comprise a rotary key with a handle (FIG. 12) which can be moved into a locked position corresponding to retraction of the pin 18 against the action of the resilient compression spring 19″

In a second embodiment of the invention shown in FIG. 14 of the accompanying drawings the element 1 or each part 1′,1″ may be associated with at least one holding device 15 to lock it in an open position. The holding device 15 comprises a supporting structure 20 extending above the element 1 or part 1′,1″, bearing on the internal wall 3 of the vat and having a catch means 21, preferably with resilient properties. The catch means 21 comes into engagement at the side edge 5 which is not interlocked with the wall 3 by the pivot connection 6 and is lifted off the wall 3 when the drainage channel 4 in question is opened.

The catch means 21 may for example comprise a wire spiral spring extended by a hook.

In a third embodiment of the invention shown in FIG. 15 of the accompanying drawings the element 1 or each part 1′,1″ is held in the open position by a holding device 15 common to a plurality of elements 1 or parts 1′,1″. The holding device 15 comprises a supporting member 22 in the form of an elongated element with curvature substantially similar to that of the internal wall 3 of the vat and provided with feet 23, which may be adjustable, designed to come to bear on the internal wall 3. The elongated element is further equipped with a plurality of catch means 24, preferably with resilient properties, designed to come into engagement at the side edges 5′ of the various elements 1 or parts 1′,1″ in order to hold them in an open position.

In a fourth embodiment of the invention shown in broken lines in FIG. 14A each holding device 15 may comprise a magnetic stud fixed either movably or immovably on the internal wall 3 of the vat.

Finally, in a very advantageous and preferred fifth embodiment of the invention and as shown in FIGS. 16 to 19 of the accompanying drawings, the spindle 8 may extend parallel with and at a spacing from the side edge 5 to which it is rigidly connected by a preferably plate-shaped interlocking bracket 25. The tubular hinge 8′, receiving the spindle with an ability to pivot and slide and fixed rigidly on the internal surface of the wall 3 of the vat, has a slot-shaped indentation 26 extending from one of its end edges and parallel with its longitudinal direction, to receive the interlocking bracket 25 through adjusted engagement of the bracket by translation.

The straight indentation will be formed in the tubular wall of the hinge 8′ in such a way that engagement of the bracket 25 in the indentation 26 corresponds to locking of the element 1 in an intermediate rotary position of the element 1 about the axis of its pivot connection 6, thus forming a device 15 for holding or indexing in a pivoted position for cleaning purposes.

The said position advantageously corresponds to rotation through between 45° and 135°, preferably about 90°, relative to its respective turned-down position in which it forms a corresponding drainage channel 4 or portion of drainage channel (FIGS. 16 to 19).

Each bracket 25 may be interlocked with the element 1 by welding or the like, or be extended by a rod or similar segment squeezed or pressed by a curved portion of the edge 5.

As also shown in the above-mentioned drawings each hinge 8′ is associated with a stop means 27 interlocked with the wall 3 and spaced from the hinge 8′ at the end edge of the latter adjacent the indentation 26, the stop means 27 limiting sliding displacement of the spindle 8/bracket 25 assembly.

In a preferred version of the invention the stop means 27 has a fixed base 27′ and a stop member 27″ mounted in or on the base 27′ and adjustable in its position, with movable locking in the sliding direction of the spindle 8/bracket 25 assembly. The stop member 27″ may in particular be adjusted in its position in such a way that it prevents the spindle 8 from sliding out of engagement with the tubular hinge 8′.

The stop member 27″, for example in the form of a screw mounted in a corresponding bore in the base 27′ and adapted to be locked in position by a nut 27″′, consequently defines the range of displacement in translation of the spindle 8 and hence the element 1, together with the end edge and, if appropriate, the end of the indentation 26 of the hinge 8′.

The stop member 27″ may equally be moved, for example by screwing, into a position allowing the spindle 8 to slide out of engagement with the hinge 8′ and thus to unlock and dismantle the profiled element 1.

The stop member 27″ may then be made up of a threaded rod mounted in a threaded bore in the base 27′ and including a manipulating nut 27″′ (FIG. 18A).

Each element 1 is preferably joined with the wall 3 by at least two pivot connections 6.

To arrive at a simple construction relative to this fifth embodiment of the invention while ensuring structural continuity between the profiled element 1 and the wall 3, each profiled element 1 is made or shaped in one piece, and in the turned-down position forming a drainage channel 4 the profiled element 1 cooperates at each of its longitudinal ends with a retaining clip 14, 14′ fixed to the wall 3 of the vat (for example by welding along their edges). Each of the clips 14, 14′ is preferably made in the form of a portion of profiled element, either containing holes or not, having a sectional shape substantially similar to that of the element 1 and defining an end of the corresponding drainage channel 4 together with the wall 3 of the vat.

In the turned-down position the profiled element 1 is preferably assembled, on the one hand, at one of its longitudinal ends with the corresponding clip 14 by means of a connecting member 28 interlocked with said end and being applied to and partly covering the clip 14, and, on the other hand, at its other longitudinal end with the corresponding clip 14′, through that end sliding in to fit below the clip 14′. The connecting member 28 and clip 14 have cooperating assembly locations arranged so as to face each other when said other end is fitted into the clip 14′.

The element 1 is further held against the wall of the vat by spaced latching means (for example 7, 7′ or the like) between the two clips 14 and 14′.

Another object of the invention is a pneumatic press, including a vat, preferably a cylindrical one, provided over part of its internal wall 3 with draining means extending parallel with the longitudinal direction of the vat and designed to recover the juices from the pressed materials and direct them towards collecting and outlet orifices, characterised in that the draining means comprise draining units of the type described above.

The invention thus makes it possible to propose a press where the juice-draining means located in the vat can be cleaned effectively, rapidly and relatively non-laboriously.

The same arrangement may of course be used for a maceration vat.

With reference to the embodiment illustrated in FIGS. 1, 4 and 5 it should be noted that passage from the normal operating arrangement (with element 1 positioned to form the drainage channel 4) to the arrangement giving access to its internal surface (with element 1 in the pivoted-back position), for a draining unit, is made in three stages, namely:

disengagement of the finger 13 from the indentation 12;

sliding of the parts 1′ and 1″ towards each other to disengage the latching means 7, 7′ and remove the ends of said parts 1′,1″ from the retaining clips 14,14″;

pivoting of said parts 1′,1″ about their hinge devices 6.

The draining unit is re-positioned to form the drainage channel 4 simply by carrying out reverse operations to the above ones, in the reverse order.

The invention is not of course limited to the embodiments described and illustrated in the accompanying drawings. Changes are still possible, particularly in respect of the make-up of the various elements or through substituting equivalent methods, without thereby going beyond the scope of protection of the invention.

1. Draining unit particularly for a press or maceration vat, comprising at least one elongated, profiled element which may possibly contain a plurality of spread-out holes, said element extending along the internal wall of the vat of the press and forming a drainage channel together with the wall through contact at two longitudinal side edges, characterised in that the profiled element (1) is interlocked with said wall (3) at one (5) of its side edges (5,5′) by means of a connection with an ability to pivot, and is provided with at least one latching and/or retaining means (7,7′; 14,14′) adapted to lock said profiled element (1) in a position with its two side edges (5,5′) resting against said internal wall (3) so as to form the drainage channel (4).

2. Draining unit according to claim 1, characterised in that the pivot connection is formed by at least two hinge plate or hinge devices (6) aligned with each other and allowing, in addition to the pivoting movement, limited relative translational displacement between the profiled element (1) and the wall (3) of the vat in a longitudinal direction parallel with the pivoting axis.

3. Unit according to claim 2, characterised in that each hinge plate device or hinge device (6) comprises a spindle (8) interlocked with one (5) of the side edges (5 and 5′) of the profiled element (1), and at least one eyelet or hinge (8′), preferably of tubular structure, fixed rigidly on the wall (3) of the vat, said spindle (8) and said at least one eyelet or hinge (8′) being mounted and extending so that they can slide a predetermined distance relative to each other.

4. Unit according to any one of claims 1 to 3, characterised in that the longitudinal side edges (5,5′) of the trough-shaped profiled element (1) are extended by inwardly folded shoulders (5″) forming two parallel bearing strips for said profiled element (1) in the position in which it is turned down to form the drainage channel (4), the profiled element (1) being shaped so that, in the turned-down position, it defines a drainage channel (4) of triangular, semi-circular, semi-elliptical or rectangular section by cooperation with the wall (3) of the vat.

5. Unit according to any one of claims 1 to 4, characterised in that the profiled element (1) or each component part (1′,1″) of the profiled element (1) is associated with a holding device (15) able to retain said element (1) or part (1′,1″) in a specific rotary position about the axis of its pivot connection (6), described as the open position, in which the side edge (5′) of the element (1) or part (1′,1″) not joined by said connection (6) to said wall (3) is located at a spacing from the wall.

6. Unit according to claim 5, characterised in that each holding device (15) locks the element (1) or part (1′,1″) in question movably in an intermediate position between the two possible rotary end positions of said element (1) or part (1′,1″) about the axis of its pivot connection (6).

7. Unit according to any one of claims 3 to 6, characterised in that the spindle (8) extends parallel with and at a spacing from the side edge (5) to which it is rigidly connected by an interlocking, preferably plate-shaped bracket (25), and that the tubular hinge (8′), which receives said spindle (8) with an ability to pivot and slide and which is fixed rigidly on the internal surface of the wall (3) of the vat, has a slot-shaped indentation (26) extending from one of its end edges and parallel with its longitudinal direction, to receive the interlocking bracket (25) through engagement of the bracket by translation.

8. Unit according to claim 7, characterised in that the straight indentation (26) is formed in the tubular wall of the hinge (8′) in such a way that engagement of the bracket (25) in the indentation (26) corresponds to locking of the element (1) in an intermediate rotary position of said element (1) about the axis of its pivot connection (6), thus forming a device (15) for holding in rotation.

9. Unit according to claim 7 or 8, characterised in that each hinge (8′) is associated with a stop means (27) interlocked with the wall (3) and located at a spacing from said hinge (8′) at the end edge of the hinge adjacent the indentation (26), said stop means (27) limiting sliding displacement of the spindle (8)/bracket (25) assembly.

10. Unit according to claim 9, characterised in that the stop means (27) has a stationary base (27′) and a stop member (27″) mounted in or on the base (27′) and adjustable in its position, with removable locking, in the sliding direction of the spindle (8)/bracket (25) assembly, the stop member (27″) in particular being adjustable in its position so as to prevent the spindle (8) from sliding out of engagement with the tubular hinge (8′).

11. Unit according to any one of claims 7 to 9, characterised in that each profiled element (1) is made or shaped in one piece, and that said profiled element (1), in the position where it is turned down to form a drainage channel (4), cooperates at each of its longitudinal ends with a retaining clip (14,14′) fixed on the wall (3) of the vat, each of said clips (14,14′) preferably being in the form of a portion of profiled element either containing or not containing holes, having a sectional shape substantially similar to that of the element (1) and defining an end of the corresponding drainage channel (4) together with the wall (3) of the vat.

12. Unit according to claim 11, characterised in that in the turned-down position the profiled element (1) is assembled, on the one hand, at one of its longitudinal ends with the corresponding clip (14) by means of a connecting member (28) interlocked with said end and applied to and partly covering said clip (14), and, on the other hand, at its other longitudinal end with the corresponding clip (14′), the connecting member (28) and clip (14) having cooperating assembly locations arranged facing each other when said other end is fitted into said clip (14′).

13. Draining unit according to any one of claims 1 to 12, characterised in that each latching means is formed by two members (7 and 7′), one (7) of which is interlocked with the profiled element (1) and the other of which is interlocked with wall (3) of the vat, the two members (7,7′) being capable of being inter-engaged to lock the profiled element (1) in position and disengaged through translation of said profiled element (1) in opposite directions.

14. Unit according to claim 13, characterised in that each latching means firstly comprises a plate (7) fixed on the profiled, trough-shaped element (1) so as to be located in the drainage channel (4) when the element (1) is turned down against the wall (3) of the vat, and having an indentation defining an eyelet (9), and secondly comprises an anchoring stud or pin (7′) with a head (10), the radial dimensions of which are larger than those of the eyelet (9), the profiled element (1) advantageously being equipped with a plurality of regularly spaced plates (7) designed to cooperate with a plurality of corresponding studs or pins (7′).

15. Unit according to any one of claims 1 to 10, characterised in that the profiled element (1) is formed by two separate, aligned and adjoining component parts (1′,1″), in which the respective latching means (7,7′)are engaged and disengaged in opposite directions, the first (1′) of said parts (1′,1″) having a profiled covering member (11), possibly containing holes, at the end of the first part (1′) facing the other part (1″), the covering member (11) bearing on and partly extending over the second part (1″) when the two parts (1′ and 1″) are turned down against the wall (3) of the vat, and defining the portion of drainage channel (4) in the space separating the two parts (1′ and 1″) in their latched positions.

16. Unit according to claim 15, characterised in that the covering member (11) has a sectional shape substantially similar to that of the two parts (1′ and 1″) and is provided with a catch hole (12), and that the second part (1″) is provided with a retractable locking stud or finger at its end facing the first part (1′), said hole (12) and said finger or stud (13) being located in a mutually coincident configuration, enabling the finger or stud (13) to extend into or through the hole (12), substantially with corresponding shapes, when the first and second parts (1′ and 1″) are in their respective latching positions.

17. Unit according to any one of claims 15 and 16, characterised in that each of the two component parts (1′ and 1″), in its respective latched position, is engaged at its end opposite the end near the other part (1″ and 1′), below or in a retaining clip (14,14′) fixed on the wall (3) of the vat, each of the clips (14,14′) preferably being in the form of a portion of profiled element either containing or not containing holes, having a sectional shape substantially similar to that of said component parts (1′,1″), and defining an end of the corresponding drainage channel (4) together with the wall (3) of the vat.

18. Unit according to any one of claims 5 and 6, characterised in that the element (1) or each of the two parts (1′,1″) forming the element (1) is associated, with a view to locking it in an open position, with at least one holding device (15) firstly comprising a lower portion (16) forming a base and being engaged with or anchored on the member (7′) of the latching means (7,7′) interlocked with the wall (3) of the vat and possibly bearing on the wall, and secondly comprising an upper portion (17) carrying a means (18) for engaging the member (7) of the latching means (7,7′) interlocked with the element (1) or part (1′,1″) in question, preferably a retaining pin (18) having an enlarged head (18′) which engages in the indentation or an indentation (9) in said member (7).

19. Unit according to claim 18, characterised in that the engagement means (18) comprises a retaining pin mounted movably in the upper portion (17) of the holding device (15) in question and equipped with a means (19) for latching said pin (18) in a retracted position for retaining the element (1) or part (1′,1″) in question, and with a resilient means (19′) which urges said pin (18) into a stretched, releasing position.

20. Unit according to any one of claims 5 and 6, characterised in that the element (1) or each part (1′,1″) is associated with at least one holding device (15) to lock it in an open position, the holding device (15) comprising a supporting structure (20) extending above said element (1) or part (1′,11″), bearing on the internal wall (3) of the vat and having a catch means (21), preferably with resilient properties, which comes into engagement at the side edge (5) which is not interlocked with the wall (3) by the pivot connection (6) and is lifted off the wall (3) when the drainage channel (4) in question is opened.

21. Unit according to any one of claims 5 and 6, characterised in that the element (1) or each part (1′,1″) is held in the open position by a holding device (15) common to a plurality of elements (1) or parts (1′,1″), the holding device (15) comprising a supporting member (22) in the form of an elongated element with curvature substantially similar to that of the internal wall (3) of the vat and provided with feet (23), which may be adjustable, designed to come to bear on the internal wall (3), and further equipped with a plurality of catch means (24), preferably with resilient properties, designed to come into engagement at the side edges (5′) of the various elements (1) or parts (1′,1″) in order to hold them in an open position.

22. Unit according to any one of claims 5 and 6, characterised in that each holding device (15) comprises a magnetic stud fixed either movably or immovably on the internal wall (3) of the vat.

23. Press, particularly a pneumatic press, including a vat, preferably a cylindrical one, provided over part of its internal wall with draining means extending parallel with the longitudinal direction of the vat and designed to recover the juices from the pressed materials and direct them towards collecting and outlet orifices, characterised in that the draining means comprise draining units according to any one of claims 1 to 22.
